(19) United States
(12) Patent Application Publication
(10) Pub. No.: US 2007/0098964 A1
(43) Pub. Date: May 3, 2007

(54) Interlayers comprising an embossed polymer film

(75) Inventor: Vincent James Yacovone, Springfield, MA (US)

Correspondence Address: BRENC LAW;ANDREW BRENC, P.O. BOX 155, ALBION, PA, 16401-0155, US

(73) Assignee: Solutia, Inc.

(21) Appl. No.: 11/264,511

(22) Filed: Nov. 1, 2005

(51) Int. Cl. B41M 5/00

(52) U.S. Cl. 428/195.1

(57) ABSTRACT

The present invention provides interlayers that comprise a metallized, embossed polymer film onto which an image has been formed with ultraviolet curable ink. The ultraviolet curable ink, upon application to the embossed surface of the polymer film, adheres evenly to the surface, without undue thickening or thinning in the low and high areas of the embossed surface. Interlayers comprising such films can be incorporated, for example, into a two glass pane multiple layer glazing. Such glazings can provide, for example, privacy for the enclosed space as well as infrared radiation control.

### FIELD OF THE INVENTION

The present invention is, generally, in the field of laminated glass, and, specifically, the present invention is in the field of laminated glass that incorporates a performance film and that is used, for example, in architectural and automotive applications.

### BACKGROUND

In automobiles and some architectural applications of multiple layer laminated safety glass, there exists a desire to reduce the solar heat load of the space enclosed by the glass. In addition, for many applications, there is a desire to provide privacy.

To reduce the heating effects resulting from such windows, selective light transmitting materials or films have been incorporated into window assemblies. These films have generally been designed to maximize rejection of incoming light in the near infrared wavelength range, maximize visible light transmittance, and minimize visible light reflectance. Selective light transmitting films are disclosed, for example, in U.S. Pat. No. 4,973,511.

Layers of metals, metal compounds, and the like are conventionally used in laminated glass to reflect heat-producing infrared solar radiation while transmitting significant cooler visible light. These metal layers are usually arranged in sequence as stacks, and are carried by an appropriate transparent planar polymeric support layer, such as biaxially stretched, thermoplastic polyethylene terephthalate film (PET) or equivalent material.

One example of a multiple layer glazing panel is provided in U.S. Patent Application 2003/0161997, which discloses the use of an embossed, metallized film in the safety glass interlayer. The resulting multiple layer glazing offers desirable safety features and optical features.

Unfortunately, embossed films present an irregular surface topography, which makes various processing steps after embossing difficult. For example, the use of conventional polymer film printing inks on the surface of embossed polymer films frequently results in an inferior result because the ink does not adhere to the film substrate at a uniform thickness.

What are needed in the art are improved techniques for modification of embossed films, such as those disclosed in U.S. Patent Application 2003/0161997.

### SUMMARY OF THE INVENTION

The present invention provides interlayers that comprise a metallized, embossed polymer film onto which an image has been formed with ultraviolet curable ink. The ultraviolet curable ink, upon application to the embossed surface of the polymer film, adheres evenly to the surface, without undue thickening or thinning in the low and high areas of the embossed surface. Interlayers comprising such films can be incorporated, for example, into a two glass pane multiple layer glazing. Such glazings can provide, for example, privacy for the enclosed space as well as infrared radiation control.

### BRIEF DESCRIPTION OF THE DRAWINGS

FIG. 1 is a schematic, cross-sectional view of one embodiment of an interlayer of the present invention shown prior to final lamination between two glass panes.

### DETAILED DESCRIPTION

The present invention is directed to interlayers for use in multiple layer glazings such as laminated safety glass. Interlayers of the present invention comprise a polymer sheet and a polymer film that together form part or all of the interlayer. As will be described in greater detail elsewhere herein, polymer sheets and polymer films can comprise any suitable material, and, in a typical example, polymer sheets comprise poly(vinyl butyral) and polymer films comprise poly(ethylene terephthalate).

Interlayers of the present invention comprise at least one polymer film that has been metallized and embossed, as will be described in detail below. Further, interlayers of the present invention will have an image formed on the surface of a polymer film with an ultraviolet curable ink, as will also be described below in detail. The combination of an embossed polymer film and ultraviolet curable inks, it has surprisingly been found, results in an interlayer that, when included in a glazing, provides for striking imagery as well as exceptional performance.

In various embodiments of the present invention, an interlayer comprises a single polymer sheet and a single polymer film. In these embodiments, the polymer film is metallized on one surface, has been embossed, and has an image formed on the other surface with ultraviolet curable ink. As used herein, an “image” means any printed graphical representation, including, for example and without limitation, geometric patterns and shapes, alphanumeric characters, artistic images, and the like. The polymer film in these embodiments is disposed in contact with the polymer sheet, and the multiple layer interlayer can be laminated to a single pane of glass to form a bilayer or, with the use of an adhesive layer, the multiple layer interlayer of these embodiments can be laminated between two panes of glass.

A bilayer formed according to the above can have the following typical configuration: glass//polymer sheet//polymer film. In these types of embodiments, a hardcoat or other scratch resistance layer, as are known in the art, can be formed on the outside surface of the polymer film to provide protection from physical damage.

A two glass layer multiple layer glazing panel according to the above can have the following typical configuration: glass//polymer sheet//polymer film//adhesive layer//glass.

A two glass layer multiple layer glazing panel according to the above can also be formed having the following typical configuration: glass//polymer sheet//polymer film//polymer sheet//glass.

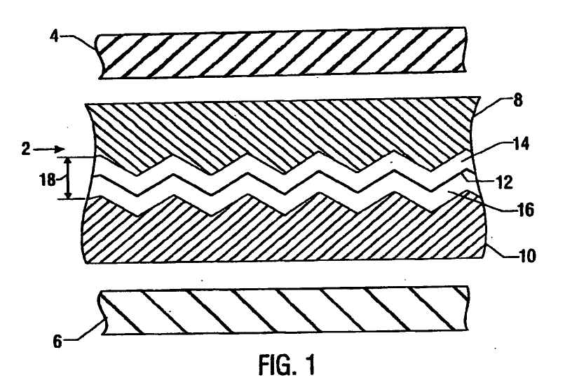

In further embodiments of the present invention, a second polymer film is bonded to the first polymer film with an adhesive, thereby forming a two layer polymer film construct. This two layer polymer film can then be embossed and an image can be formed on an outer surface using an ultraviolet curable ink. As shown in FIG. 1 generally at 2, an interlayer having a two polymer film construction has a first polymer sheet 8 and a second polymer sheet 10 between which is disposed a two layer polymer film construct 18. The two layer polymer film construct comprises a first polymer film 14 and a second polymer film 16, at least one of which has a deposited metallized layer 12. An adhesive layer adjacent the metallized layer 12 is not shown. Further, an image formed with ultraviolet curable ink on the surface of the two layer polymer film construct 18 disposed against the first polymer sheet 8 and/or the second polymer sheet 10 is not shown. Rigid substrates 4 and 6 are also shown, prior to lamination with the interlayer 2. In addition to the embodiment shown in FIG. 1, a two layer polymer film construct can be used as well with any of the interlayers and glazings described for a single polymer film construct, and specifically for constructs having the following two arrangements:

glass // polymer sheet // two polymer film construct // adhesive
layer // glass
glass // polymer sheet // two polymer film construct (bilayer)

As will be recognized by those of skill in the art, other variations of interlayers and glazings using the embossed polymer films with ultraviolet curable ink images are possible. In various embodiments, for example, multiple, thinner polymer sheets can be used in place of a single, thicker polymer sheet. Further, additional layers of polymer sheet can generally be added, where appropriate. For example, for the embodiment shown in FIG. 2, either the first or the second polymer sheet could be replaced with two or more polymer sheets. Further polymer films and other layers can also be added, where desired, to achieve various other effects and/or for ease of manufacture.

Polymer Films

As used herein, a “polymer film” means a relatively thin and rigid polymer layer that functions as a performance enhancing layer. Polymer films differ from polymer sheets, as used herein, because polymer films do not themselves provide the necessary impact resistance and glass retention properties to a multiple layer glazing structure, but rather provide performance improvements, such as infrared absorption character. Poly(ethylene terephthalate) is most commonly used as a polymer film.

Polymer films used in the present invention can be any suitable film that is sufficiently rigid to provide a relatively flat, stable surface, for example those polymer films conventionally used as a performance enhancing layer in multiple layer glass panels, and that can also be embossed and receive an ink image. The polymer film is preferably optically transparent (i.e. objects adjacent one side of the layer can be comfortably seen by the eye of a particular observer looking through the layer from the other side), and usually has a greater, in some embodiments significantly greater, tensile modulus regardless of composition than that of the adjacent polymer sheet. In various embodiments, the polymer film comprises a thermoplastic material. Among thermoplastic materials having suitable properties are nylons, polyurethanes, acrylics, polycarbonates, polyolefins such as polypropylene, cellulose acetates and triacetates, vinyl chloride polymers and copolymers, and the like. In various embodiments, the polymer film comprises materials such as re-stretched thermoplastic films having the noted properties, which include polyesters. In various embodiments, the polymer film comprises or consists of poly(ethylene terephthalate), and, in various embodiments, the poly(ethylene terephthalate) has been biaxially stretched to improve strength, and/or has been heat stabilized to provide low shrinkage characteristics when subjected to elevated temperatures (e.g. less than 2% shrinkage in both directions after 30 minutes at 150° C.).

In various embodiments, a polymer film can have a thickness of 0.013 millimeters to 0.25 millimeters, 0.025 millimeters to 0.1 millimeters, or 0.04 to 0.06 millimeters.

A polymer film can optionally be surface treated or coated with a functional performance layer to improve one or more properties, such as adhesion or infrared radiation reflection. These functional performance layers include, for example, a multi-layer stack for reflecting infra-red solar radiation and transmitting visible light when exposed to sunlight. This multi-layer stack is known in the art (see, for example, WO 88/01230 and U.S. Pat. No. 4,799,745) and can comprise, for example, one or more Angstroms-thick metal layers and one or more (for example, two) sequentially deposited, optically cooperating dielectric layers. As is also known (see, for example, U.S. Pat. Nos. 4,017,661 and 4,786,783), the metal layer(s) may optionally be electrically resistance heated for defrosting or defogging of any associated glass layers. Various coating and surface treatment techniques for poly(ethylene terephthalate) films and other polymer films that can be used with the present invention are disclosed in published European Application No. 0157030. Polymer films of the present invention can also include a hardcoat and/or an antifog layer, as are known in the art.

A polymer film has two surfaces, which, as used herein, are said to be “opposite” one another.

In various embodiments of the present invention, polymer films can be colored using conventionally known dyes and/or pigments.

Metallization

Techniques for the formation of a metal layer on a polymer film are well known in the art. Metals can be deposited on a film, for example, using vapor deposition techniques or sputtering techniques.

Suitable metals include silver, aluminum, chromium, nickel, zinc, copper, tin, gold, and alloys thereof as well as other alloys such as brass and stainless steel. In various embodiments, the metallized layer comprises aluminum. The metallized polymer film or films of the present invention preferably have a visible light transmittance ranging from about 2% to about 95%. Transmittance can be affected by many factors, as is known in the art. Generally, the thicker the metal coating in the metallized film, the lower the visible transmittance and the higher the visible reflection.

Embossing

The polymer film or films of the present invention are purposefully embossed in a pattern so that there are protrusions of the polymer film surface at different angles to the normal, flat plane of the non-embossed film. Such protrusions can be in a regular pattern, such as regular diamond like protrusions as described in U.S. Pat. No. 4,343,848, or irregular or random pattern, such as one that is commonly known as “orange peel.” Other textures can also be used, and are within the scope of this invention. Such other textures can range, for example, from simple repeating patterns to corporate logos, depending on the desired end product.

The textured surface pattern of the embossed film greatly reduces the glare and the visibility of any surface deformities in laminates that are normally associated with such films. Furthermore, highly reflective, flat metallized films are generally more unattractive because of the ease in which the general nonplanarity of the metallized film within the laminate can be observed. The effects of these shortcomings are optically non-uniform surfaces that result in distorted reflected images. Using embossed, metallized films with high visible reflectance eliminates these problems, as a uniformly textured surface hides defects in the metallized film and results in a very diffuse reflected image that is aesthetically more appealing than the above described mirror-like appearance that is encountered with flat reflective films.

In order to form the embossed film, which can comprise a single polymer film or two polymer films, the film can be, for example, subjected to a nip roll embossing process that is known well in the art. This process uses two cylindrical rollers, one of which has a soft surface and the other of which has a hard surface with an engraved texture. The film is usually preheated using either infrared or convection heating prior to embossing in order to soften the film and make it more compliant during the embossing process. The film is transported through the nip, and, using sufficient heat and pressure, the texture of the engraved roll is imparted to the film.

Bonding Adhesive

The adhesive used for bonding two polymer films can be any suitable adhesive that is compatible with the high temperatures (upwards of 150° C.) utilized during a typical autoclave laminate processing. The adhesive should also retain its adhesive properties throughout the embossing and laminating steps. Acceptable adhesives include any crosslinked adhesive system such as systems comprising polyesters, urethanes, acrylics, isocyanate crosslinked polyester, and the like. In various embodiments, isocyanates crosslinked polyester is used to bond two polymer films.

Ultraviolet Curable Ink

As used herein, an “ultraviolet curable ink” means any ink that can be cured through exposure to ultraviolet radiation. Ultraviolet curable inks typically comprise a vehicle, pigments, photoinitiators, and, optionally, additives, although other variations are possible.

Vehicles generally contain a polymeric resin and a diluent. In various embodiments of the present invention, a resin is made from one or more of the following acrylates: epoxy, urethane, and polyester, which are known as “free radical” systems.

Other acrylate systems form acid radicals when they undergo cationic curing, which facilitates polymerization. These systems have a relatively low degree of film shrinkage. These resins include, without limitation, aliphatic urethanes, cycloaliphatic epoxides, and vinyl ethers. These are sometimes used in inkjet systems.

Appropriate reactive monomers can be used as diluents in free radical ultraviolet curable inks, while various glycols and/or alcohols can be used for cationic diluents.

Pigments can be chosen based on the ultraviolet curable ink formulation and on the printing system that will be used to form images.

Photoinitiators can be selected from a wide variety of available agents, as are known in the art. Photoinitiators can be used in combination as well as alone. The photoinitiator will generally be chosen based on the desired overall cure response, post cure time, cure rate, print hardness, and chemical resistance.

Ultraviolet curable ink components that are suitable for use with the present invention, include, but are not limited to, 1,6 hexanediol diacrylate (HDDA), urethane monoacrylate (UMA), diethylene glycol monomethyl ether acrylate (DEMA), dipropylene glycol monomethyl ether acetate (DPGMA), trimethylolpropane ethoxy triacetate (TMPEOTA), and alkoxylated pentaerythritol tetraacrylate (OPETIA).

In various embodiments of the present invention, diluting acrylates above a surface tension of 0.035 Newtons per meter at 25° C. are used. Useful additives include aliphatic urethanes from 1% to 40% by weight. Preferred resins include materials with an aliphatic polyester backbone structure.

Ultraviolet curable inks that are commercially available include Vutek PressVu 180 UV cured ink set (CMYK) and Vutek PressVu 200 UV cured ink set (CMYKW).

Ultraviolet curable inks can be applied to a polymer film in any suitable manner. Image printing is well known in the art, and conventional methods, such as gravure and inkjet printing, can be used to form an image. In various embodiments, inkjet printing is used to form an image on a polymer film using an ultraviolet curable ink.

Within the scope of the present invention are variations in the arrangement of the different elements. For example, a polymer film having two metallized surfaces could be formed and bonded between two other polymer films, resulting in a three layer structure. The three film structure could then have an image formed from ultraviolet curable ink on one or both surfaces prior to lamination into a finished product.

Polymer Sheets

As used herein, a “polymer sheet” means any polymer composition formed by any suitable method into a thin layer that is suitable alone, or in stacks of more than one. layer, for use as an interlayer that provides adequate penetration resistance and glass retention properties to laminated glazing panels. Plasticized poly(vinyl butyral) is most commonly used to form polymer sheets.

The polymer sheets of the present invention can comprise any suitable polymer, and, in one embodiment, as exemplified above, a polymer sheet comprises poly(vinyl butyral). In other embodiments, a polymer sheet comprises polyurethane. In any of the embodiments of the present invention given herein that comprise poly(vinyl butyral) as the polymeric component of the polymer sheet, another embodiment is included in which the polymer component consists of or consists essentially of poly(vinyl butyral). In these embodiments, any of the variations in additives, including plasticizers, disclosed herein can be used with the polymer sheet having a polymer consisting of or consisting essentially of poly(vinyl butyral).

In one embodiment, the polymer sheet comprises a polymer based on partially acetalized poly(vinyl alcohol)s. In further embodiments the polymer sheet comprises poly(vinyl butyral) and one or more other polymers. In any of the sections herein in which preferred ranges, values, and/or methods are given specifically for poly(vinyl butyral) (for example, and without limitation, for plasticizers, component percentages, thicknesses, and characteristic-enhancing additives), those ranges also apply, where applicable, to the other polymers and polymer blends disclosed herein as useful components in polymer sheets.

For embodiments comprising poly(vinyl butyral), the poly(vinyl butyral) can be produced by any suitable method. Details of suitable processes for making poly(vinyl butyral) are known to those skilled in the art (see, for example, U.S. Pat. Nos. 2,282,057 and 2,282,026). In one embodiment, the solvent method described in Vinyl Acetal Polymers, in Encyclopedia of Polymer Science & Technology, 3^{rd} edition, Volume 8, pages 381-399, by B. E. Wade (2003) can be used. In another embodiment, the aqueous method described therein can be used. Poly(vinyl butyral) is commercially available in various forms from, for example, Solutia Inc., St. Louis, Mo. as Butvar™ resin.

In various embodiments, the resin used to form polymer sheet comprising poly(vinyl butyral) comprises 10 to 35 weight percent (wt. %) hydroxyl groups calculated as poly(vinyl alcohol), 13 to 30 wt. % hydroxyl groups calculated as poly(vinyl alcohol), or 15 to 22 wt. % hydroxyl groups calculated as poly(vinyl alcohol). The resin can also comprise less than 15 wt. % residual ester groups, 13 wt. %, 11 wt. %, 9 wt. %, 7 wt. %, 5 wt. %, or less than 3 wt. % residual ester groups calculated as polyvinyl acetate, with the balance being an acetal, preferably butyraldehyde acetal, but optionally including other acetal groups in a minor amount, for example, a 2-ethyl hexanal group (see, for example, U.S. Pat. 5,137,954).

In various embodiments, the polymer sheet comprises poly(vinyl butyral) having a molecular weight at least 30,000, 40,000, 50,000, 55,000, 60,000, 65,000, 70,000, 120,000, 250,000, or at least 350,000 grams per mole (g/mole or Daltons). Small quantities of a dialdehyde or trialdehyde can also be added during the acetalizafion step to increase molecular weight to at least 350 g/m (see, for example, U.S. Pat. Nos. 4,902,464; 4,874,814; 4,814,529; and 4,654,179). As used herein, the term “molecular weight” means the weight average molecular weight.

Various adhesion control agents can be used in polymer sheets of the present invention, including sodium acetate, potassium acetate, and magnesium salts.

Magnesium salts that can be used with these embodiments of the present invention include, but are not limited to, those disclosed in U.S. Pat. No. 5,728,472, such as magnesium salicylate, magnesium nicotinate, magnesium di-(2-aminobenzoate), magnesium di-(3-hydroxy-2-napthoate), and magnesium bis(2-ethyl butyrate) (chemical abstracts number 79992-76-0). In various embodiments of the present invention the magnesium salt is magnesium bis(2-ethyl butyrate).

In various embodiments of polymer sheets of the present invention, the polymer sheets can comprise 5 to 60, 25 to 60, 5 to 80, or 10 to 70 parts plasticizer per one hundred parts of resin (phr). Of course other quantities can be used as is appropriate for the particular application. In some embodiments, the plasticizer has a hydrocarbon segment of fewer than 20, fewer than 15, fewer than 12, or fewer than 10 carbon atoms.

The amount of plasticizer can be adjusted to affect the glass transition temperature (Tg) of the poly(vinyl butyral) sheet. In general, higher amounts of plasticizer are added to decrease the T_{g}. Poly(vinyl butyral) polymer sheets of the present invention can have a T_{g} of, for example, 40° C. or less, 35° C. or less, 30° C. or less, 25° C. or less, 20° C. or less, and 15° C. or less.

Any suitable plasticizers can be added to the polymer resins of the present invention in order to form the polymer sheets. Plasticizers used in the polymer sheets of the present invention can include esters of a polybasic acid or a polyhydric alcohol, among others. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, mixtures of phosphates and adipates such as disclosed in U.S. Pat. No. 3,841,890 and adipates such as disclosed in U.S. Pat. No. 4,144,217, and mixtures and combinations of the foregoing. Other plasticizers that can be used are mixed adipates made from C₄ to C₉ alkyl alcohols and cyclo C₄ to C₁₀ alcohols, as disclosed in U.S. Pat. No. 5,013,779 and C₆ to C₈ adipate esters, such as hexyl adipate. In various embodiments, the plasticizer used is dihexyl adipate and/or triethylene glycol di-2 ethylhexanoate.

In various other embodiments of the present invention, polymer sheets comprise a polymer selected from the group consisting of poly(vinyl butyral), polyurethane, polyvinyl chloride, poly(ethylene-co-vinyl acetate), polyethylene, polyethylene copolymers, partially neutralized ethylene/(meth)acrylic copolymers, combinations thereof, and the like.

Various embodiments include poly(ethylene-co-vinyl acetate) as described in U.S. Pat. Nos. 4,614,781, 5,415,909, 5,352,530, and 4,935,470. Various embodiments include polyurethane comprising, for example, aliphatic isocyanate polyether based polyurethane (available from Thermedics Polymer Products of Noveon Inc.). Other additives can be incorporated into the polyurethane resins during extrusion, such as ultraviolet stabilizers and finctional chemicals to provide high adhesion to glass.

Polymeric resins can be thermally processed and configured into sheet form according to methods known to those of ordinary skill in the art. As used herein, “resin” refers to the polymeric (for example poly(vinyl butyral) or poly(vinyl chloride)) component of a polymer composition. Resin will generally have other components in addition to the polymer, for example, components remaining from the polymerization process. As used herein, “melt” refers to a melted mixture of resin with a plasticizer, if required, and optionally other additives, for example, performance enhancing agents. One exemplary method of forming a poly(vinyl butyral) sheet comprises extruding molten poly(vinyl butyral) comprising resin, plasticizer, and additives—the melt—by forcing the melt through a sheet die (for example, a die having an opening that is substantially greater in one dimension than in a perpendicular dimension). Another exemplary method of forming a poly(vinyl butyral) sheet comprises casting a melt from a die onto a roller, solidifying the resin, and subsequently removing the solidified resin as a sheet.

Polymer sheets can be produced through conventional coextrusion and extrusion coating processes as well.

Polymer sheets of the present invention can have, for example and without limitation, a thickness of 0.25 to 2.0 millimeters, depending on the number of polymer sheets used, with a total thickness of all polymer sheets of, for example, 0.75 to 1.75 millimeters. Interlayers of the present invention can have a total thickness of, for example and without limitation, 1.0 to 2.0 millimeters.

Additives may be incorporated into the polymer sheet to enhance its performance in a final product. Such additives include, but are not limited to, the following agents: antiblocking agents, plasticizers, dyes, pigments, stabilizers (e.g., ultraviolet stabilizers), antioxidants, flame retardants, infrared absorbers, combinations of the foregoing additives, and the like, as are known in the art.

Polymer layers and/or glass layers of the present invention can be laminated using any conventional technique. Polymer layers can be prelaminated prior to final lamination, for example, by applying sufficient heat and/or pressure to tack polymer sheets and/or polymer films together. The prelaminate can then be disposed in contact with a glazing substrate and/or other polymer layers and laminated to form a laminated panel.

The surface layers of polymer films in contact with polymer sheets preferably are appropriately coated and/or treated to achieve adequate adhesion and laminate integrity. Preferred techniques are roughening of the surface of the polymer film or by chemical modification of the polymer film surface. Such modification can be effected by flame treatment, chemical oxidation, corona discharge, carbon sputtering, plasma treatment in vacuum or in air, application of an adhesive, or other treatments well known to those of ordinary skill in the art.

It is often desirable to add an infrared (IR) light absorber to one or more polymer sheets in order to reduce the solar energy that is transmitted through the laminate. It is known that nanoparticles of various inorganic oxides can be dispersed within a resin binder to form coatings or layers that absorb particular wavelength bands of infrared energy while allowing high levels of transmission of visible light. Antimony doped tin oxide and tin doped indium oxide can be used, for example (see U.S. Pat. Nos. 5,807,511 and 5,518,810). Lanthanum hexaboride (LaB₆) can also be used with inorganic oxides to provide a reduction in infrared transmission (see, for example, European Patent application EP-A-1008564).

In various embodiments of the present invention, an interlayer is provided that includes a portion that has a metallized, embossed polymer film with an image formed thereon in an ultraviolet curable ink of the present invention. Such embodiments include, for example and without limitation, interlayers that are produced with the gradient region as the above-referenced portion. Such embodiments are useful for producing laminated windshields having an aesthetically pleasing image formed in the gradient region.

The present invention includes multiple layer glass panels comprising any interlayers of the present invention.

The present invention includes methods of making interlayers and multiple layer glass panels comprising forming any of the interlayers and glass panels of the present invention by the methods described herein.

The present invention includes multiple layer glazing panels, and specifically multiple layer glass panels such as architectural safety glass and automobile windshields, comprising any of the interlayers of the present invention.

The present invention includes methods of manufacturing a multiple layer glass panel, comprising disposing any of the interlayers of the present invention, with or without additional polymeric layers, between two panes of glass and laminating the stack.

Also included in the present invention are stacks or rolls of any of the polymer interlayers of the present invention disclosed herein.

For any embodiment given herein comprising a layer of glass, an equivalent embodiment exists, where appropriate, comprising a rigid glazing substrate other than glass. In these embodiments, the rigid substrate can comprise acrylic such as Plexiglass®, polycarbonate such as Lexan®, and other plastics that are conventionally used in glazings.

Various polymer sheet and/or laminated glass characteristics and measuring techniques will now be described for use with the present invention.

The clarity of a polymer sheet can be determined by measuring the haze value, which is a quantification of the light scattered by a sample in comparison to the incident light. The percent haze can be measured according to the following technique. An apparatus for measuring the amount of haze, a Hazemeter, Model D25, which is available from Hunter Associates (Reston, Va.), can be used in accordance with ASTM D1003-61 (Re-approved 1977)-Procedure A, using Illuminant C, at an observer angle of 2 degrees. In various embodiments of the present invention, percent haze is less than 5%, less than 3%, and less than 1%.

Pummel adhesion can be measured according to the following technique, and where “pummel” is referred to herein to quantify adhesion of a polymer sheet to glass, the following technique is used to determine pummel. Two-ply glass laminate samples are prepared with standard autoclave lamination conditions. The laminates are cooled to about −17.8° C. (0° F.) and manually pummeled with a hammer to break the glass. All broken glass that is not adhered to the polymer sheet is then removed, and the amount of glass left adhered to the polymer sheet is visually compared with a set of standards. The standards correspond to a scale in which varying degrees of glass remain adhered to the poly(vinyl butyral) sheet. In particular, at a pummel standard of zero, no glass is left adhered to the polymer sheet. At a pummel standard of 10, 100% of the glass remains adhered to the polymer sheet. For laminated glass panels of the present invention, various embodiments have a pummel of at least 3, at least 5, at least 8, at least 9, or 10. Other embodiments have a pummel between 8 and 10, inclusive.

The “yellowness index” of a polymer sheet can be measured according to the following: transparent molded disks of polymer sheet 1 cm thick, having smooth polymeric surfaces which are essentially plane and parallel, are formed. The index is measured according to ASTM method D 1925, “Standard Test Method for Yellowness Index of Plastics” from spectrophotometric light transmittance in the visible spectrum. Values are corrected to 1 cm thickness using measured specimen thickness. In various embodiments of the present invention, a polymer sheet can have a yellowness index of 12 or less, 10 or less, or 8 or less.

Transmittances can be measured using a Perkin-Elmer Lambda 900 spectrophotometer with a 150 mm diameter integrating sphere, calculated using the D65 Illuminant with 10° observer and following the ISO 9050 (air mass 2) standard.

By virtue of the present invention, it is now possible to provide interlayers comprising embossed, metallized polymer films that have images formed from ultraviolet curable inks. Glazing panels incorporating such polymer films are both functional and decorative.

While the invention has been described with reference to exemplary embodiments, it will be understood by those skilled in the art that various changes may be made and equivalents may be. substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, a polymer sheet can be formed comprising poly(vinyl butyral) in any of the ranges given in addition to any of the ranges given for plasticizer, to form many permutations that are within the scope of the present invention.

Figures are understood to not be drawn to scale unless indicated otherwise.

Each reference, including journal articles, patents, applications, and books, referred to herein is hereby incorporated by reference in its entirety.

1. A glazing interlayer, comprising:
a first polymer sheet;
a first polymer film disposed in contact with said first polymer sheet, wherein said first polymer film comprises a metallized layer and wherein said first polymer film is embossed; and,
an ink image formed on said first polymer film opposite said metallized layer, wherein said ink image comprises an ultraviolet curable ink.

2. The glazing interlayer of claim 1, wherein said first polymer sheet comprises poly(vinyl butyral).

3. The glazing interlayer of claim 1, wherein said first polymer film comprises poly(ethylene terephthalate).

4. The glazing interlayer of claim 1, further comprising:
an adhesive layer disposed in contact with said metallized layer; and,
a second polymer film disposed in contact with said adhesive layer.

5. The glazing interlayer of claim 4, wherein said first polymer sheet comprises poly(vinyl butyral).

6. The glazing interlayer of claim 4, wherein said first polymer sheet comprises polyurethane.

7. The glazing interlayer of claim 4, wherein said first polymer film and said second polymer film each comprise poly(ethylene terephthalate).

8. The glazing interlayer of claim 4, further comprising a second polymer sheet disposed in contact with said second polymer film.

9. A glazing comprising a glazing interlayer, wherein said glazing interlayer comprises:
a first polymer sheet;
a first polymer film disposed in contact with said first polymer sheet, wherein said first polymer film comprises a metallized layer and wherein said first polymer film is embossed; and,
an ink image formed on said first polymer film opposite said metallized layer, wherein said ink image comprises an ultraviolet curable ink.

10. The glazing of claim 9, wherein said first polymer sheet comprises poly(vinyl butyral).

11. The glazing of claim 9, wherein said first polymer film comprises poly(ethylene terephthalate).

12. The glazing of claim 9, further comprising:
an adhesive layer disposed in contact with said metallized layer; and,
a second polymer film disposed in contact with said adhesive layer.

13. The glazing of claim 12, wherein said first polymer sheet comprises poly(vinyl butyral).

14. The glazing of claim 12, wherein said first polymer sheet comprises polyurethane.

15. The glazing of claim 12, wherein said first polymer film and said second polymer film each comprise poly(ethylene terephthalate).

16. The glazing of claim 12, further comprising a second polymer sheet disposed in contact with said second polymer film.

17. A glazing interlayer, comprising:
a first polymer sheet;
a second polymer sheet;
an embossed polymer film composite comprising:
a first polymer film;
a metallized layer disposed on a surface of said first polymer film;
an adhesive layer disposed on said first polymer film opposite said metallized layer;
a second polymer layer disposed in contact with said adhesive layer; and
an ink image formed on said embossed polymer film composite, wherein said ink image comprises an ultraviolet curable ink and wherein said embossed polymer film is disposed between said first polymer sheet and said second polymer sheet.
